(19) United States
(12) Patent Application Publication
(10) Pub. No.: US 2013/0185216 A1
(43) Pub. Date: Jul. 18, 2013

(54) COMPUTER SYSTEM FOR CALCULATING COUNTRY-SPECIFIC FEES

(71) Applicants: Justin Ryan Simpson, Sydney (AU); John Wilfred Adailkalam Selvaraj, Sydney (AU); Aarthy Meyappan, Sydney (AU); Dipti Patel, Sydney (AU); Sasmita Ray, Sydney (AU)

(72) Inventors: Justin Ryan Simpson, Sydney (AU); John Wilfred Adailkalam Selvaraj, Sydney (AU); Aarthy Meyappan, Sydney (AU); Dipti Patel, Sydney (AU); Sasmita Ray, Sydney (AU)

(73) Assignee: INOVIA HOLDINGS PTY LTD, Sydney, New South Wales (AU)

(21) Appl. No.: 13/823,283

(22) PCT Filed: Sep. 14, 2011
(86) PCT No.: PCT/AU2011/001178

§ 371 Date: Apr. 2, 2013

(30) Foreign Application Priority Data
Sep. 16, 2010 (AU) 2010904178

(51) Int. Cl. G06Q 50/18

(52) U.S. Cl. CPC G06Q 50/184; G06Q 30/0283
USPC 705/310

(57) ABSTRACT

The present invention relates to computer systems for estimating foreign filing costs, in particular, to a computer-implemented system for generating country-specific fees. The computer system is designed to receive an industrial property (IP) identifier, such as a patent number, generate IP statistics corresponding to the IP identifier, such as the number of words and pages in a patent specification, generate a set of selected countries and, for every selected country; identify a selected fee rule corresponding to that country and apply the selected fee rule to the IP statistics to calculate a country-specific fee. The computer system preferably performs these steps in response to a single user action.

### FIELD OF THE INVENTION

The present invention relates to a computer system for calculating country-specific fees.

The invention has been developed specifically for calculating the foreign filing costs for industrial property matters where the filing of multiple applications or other submissions are required, and will be described below with reference to that application. However, it will be appreciated that it is not limited to that particular use, and is also suitable for estimating the cost of other actions for multijurisdictional submissions to government or other entities.

### DISCUSSION OF THE PRIOR ART

Current methods of generating cost estimates for filing foreign patent applications are generally very manual processes. The applicant of a given patent application in a given jurisdiction will typically ask his, her or its local attorney how much it will cost to file one or more proposed patent applications outside the applicant's home country or region, where that proposed application is, or those proposed applications are, to be based upon the given patent application. The attorney then manually produces a general cost estimate based upon an average cost of previously filed cases or simply obtains fresh estimates for the proposed applications directly from attorneys or agents practicing in the countries of interest to the applicant.

It will be appreciated that the patent applicant is the client of the local attorney, and unless the context clearly dictates otherwise, the two terms “client” and “patent applicant” are used interchangeably. Moreover, the terms “attorney”, “patent attorney”, “foreign attorney”, “local attorney”, “representative”, “legal representative”, “agent” and the like are all used to indicate a legal relationship, typically with the client or applicant, of a third party service provider.

One disadvantage of such prior art methods is that estimates which are based upon average costs are highly inaccurate. In most countries, translation costs vary according to the size of the patent specification and government fees (also known as official fees) vary according to the number of claims or pages in the patent specification. As such, while an average cost is relatively administratively convenient to calculate, it can often be inaccurate, making it less than ideal for budgeting purposes.

If the attorney chooses to obtain a more accurate cost estimate that is specific to the proposed application or applications, this will involve considerable time and effort to achieve with any real degree of accuracy. For example, if an applicant asks for a cost estimate in multiple countries, the attorney has to write to all of his/her foreign attorneys to request the estimates, then receive and compile them in the local currency for the applicant. This administrative effort is incurred by both the local attorney and the foreign attorneys. Alternatively, the local attorney needs to manually go through a schedule of charges for each foreign attorney and try to generate a cost estimate from those numbers. This process takes a lot of time, which the local attorney would likely preferentially spend on higher level matters. The time involved can also negatively affect the client, especially where deadlines are looming for having the proposed application or applications filed.

A further disadvantage of prior art methods is that in order to generate an accurate cost estimate for a proposed foreign application, certain statistics or characteristics need to be known about the piece of industrial property. In the case of patents, for example, these statistics typically include the number of words in the associated patent specification, the number of pages in that specification, and the number of claims in that specification. This information is usually obtained by an administrator undertaking a manual count of the pages and other aspects of the specification to gather the required statistics. Following from this, the administrator will then manually multiply the gathered statistics by the respective amounts gained from fee schedules provided by foreign attorneys. The process of manually finding those pieces of data and accurately calculating a foreign patent filing is usually too onerous for most attorneys/administrators to thoroughly pursue and hence the accuracy of the cost estimate is compromised.

Similar problems exist for filing other IP property matters be they trademark, copyright, utility model, design registrations or other like matters.

It is an object of the present invention to overcome or ameliorate at least one of the disadvantages of the prior art or to provide a useful alternative.

### DISCLOSURE OF THE INVENTION

According to a first aspect of the present invention there is disclosed a computer system for calculating country-specific fees, the computer system includes a processing computer having a central processing unit and a computer-readable storage medium having instructions stored thereon and being configured to:
(a) receive an industrial property (IP) identifier;
(b) generate IP statistics corresponding to the IP identifier;
(c) generate a set of selected countries; and
(d) for each selected country:
   (i) identify a selected fee rule corresponding to that country; and
   (ii) apply the selected fee rule to the IP statistics to calculate a country-specific fee.

Preferably, the computer system is configured to calculate the country-specific fees in response to a single user action. More preferably, the system includes an interface, and the single user action is the provision of the IP identifier by the user to the interface. Even more preferably, the system is responsive to the entry of the IP identifier to the interface for automatically calculating the country-specific fee.

According to a second aspect of the present invention there is disclosed a computer-implemented method of calculating country-specific fees including the steps of,

in a computer system having a processing computer having a central processing unit and a computer-readable storage medium having instructions stored thereon:
(a) receiving an industrial property (IP) identifier;
(b) generating IP statistics corresponding to the IP identifier;
(c) generating a set of selected countries; and
(d) for each selected country:
   (i) identifying a selected fee rule corresponding to that country; and
   (ii) applying the selected fee rule to the IP statistics to calculate a country-specific fee.

Preferably, the computer-implemented method includes the step of calculating the country-specific fees in response to a single user action. More preferably, the single user action is the provision of the IP identifier.

According to a third aspect of the present invention there is disclosed a computer system for calculating country-specific fees,

the computer system including a processing computer having a central processing unit and a computer-readable storage medium having instructions stored thereon and being configured to:
(a) receive an industrial property (IP) identifier;
(b) generate IP statistics corresponding to the IP identifier;
(c) generate a set of selected countries;
(d) identify at least one attorney associated with the selected country; and
(e) for each selected country and attorney pair:
   (i) identify a selected fee rule corresponding to that country and attorney pair; and
   (ii) apply the selected fee rule to the IP statistics to calculate a foreign filing fee.

According to a fourth aspect of the present invention there is disclosed a computer system for calculating country-specific fees,

the computer system including a processing computer having a central processing unit and a computer-readable storage medium having instructions stored thereon and being in communication with an IP database and a client database,

the IP database being configured to store applicant and legal representative data corresponding to a plurality of IP records, and

the client database being configured to store a plurality of client identifiers and associated client preference data,

the computer system being configured to:
(a) receive an industrial property (IP) identifier;

(b) generate IP statistics corresponding to the IP identifier;
(c) retrieve, from the IP database, applicant and legal representative data relating to the IP identifier;
(d) search the client database to find a selected client identifier matching one of the applicant or legal representative data,
(e) apply client preference data corresponding to the selected client identifier to generate a set of selected countries; and
(f) for each selected country:
   (i) identify a selected fee rule corresponding to that country; and
   (ii) apply the selected fee rule to the IP statistics to calculate a country-specific foreign filing fee.

According to a fifth aspect of the present invention there is disclosed a computer system for calculating country-specific fees,

the computer system including a processing computer having a central processing unit and a computer-readable storage medium having instructions stored thereon and being in communication with an IP database and a client database,

the IP database being configured to store applicant and legal representative data corresponding to a plurality of IP records, and

the client database being configured to store a plurality of client identifiers and associated client preference data,

the computer system being configured to:
(a) receive an industrial property (IP) identifier;
(b) generate IP statistics corresponding to the IP identifier;
(c) retrieve, from the IP database, applicant and legal representative data relating to the IP identifier;
(d) search the client database to find a selected client identifier matching one of the applicant or legal representative data,
(e) apply client preference data corresponding to the selected client identifier to generate a set of selected countries and at least one attorney associated with the selected country; and
(f) for each selected country and attorney pair:
   (i) identify a selected fee rule corresponding to that country and attorney pair; and
   (ii) apply the selected fee rule to the IP statistics to calculate a foreign filing fee.

According to a sixth aspect of the present invention there is disclosed a computer system for calculating a fee for undertaking one or more predetermined actions in respect of an intellectual property (IP) application, where the computer system includes a processing computer having a central processing unit and a computer-readable storage medium having instructions stored thereon and being executable to allow the system to:
(a) receive an IP identifier for the application;
(b) generate IP statistics in response to the IP identifier;
(c) generate a set of selected countries; and
(d) for each country in the set of selected countries:
   (i) identify a selected fee rule; and
   (ii) being responsive to the selected fee rule and the IP statistics to calculate the fee for the one or more predetermined actions in the corresponding country.

In an embodiment, the set includes at least two countries.

In an embodiment, the IP statistics are indicative of at least two characteristics of the IP application.

In an embodiment, the system includes an interface and the IP identifier is received from an interface.

In an embodiment, the interface is instantiated on a client computer.

In an embodiment, the system is responsive to receiving the IP identifier for automatically calculating the fee or fees.

In an embodiment, the system is responsive to the calculation of the fee for generating cost data indicative of the fee.

In an embodiment, the cost data is communicated to the client computer. In other embodiments, the cost data is communicated by email. In further embodiments, the storage medium is updated to include the cost data.

In an embodiment, the interface is responsive to the calculation of the fee for displaying cost data indicative of the fee.

In an embodiment, the cost data is indicative of the fee or each fee. In other embodiments, the cost data is indicative of the sum of the fee or each fee. In further embodiments, the cost data is indicative of both: the fee or each fee; and the sum of the fee or each fee.

According to a seventh aspect of the present invention there is disclosed a computer system for calculating a fee for undertaking one or more predetermined actions in respect of an intellectual property (IP) application, where the computer system includes a processing computer having a central processing unit and a computer-readable storage medium having instructions stored thereon and being executable to allow the system to:
(a) provide an interface for instantiation on a client computer that is remotely connected to the system via a network;
(b) receive from the interface via the network an IP identifier for the application;
(c) generate IP statistics in response to the IP identifier;
(d) generate a set of selected countries;
(e) for each country in the set of selected countries:
   i. identify a selected fee rule; and
   ii. being responsive to the selected fee rule and the IP statistics to calculate the fee for the one or more predetermined actions in the corresponding country; and
(f) providing to the interface cost data that is indicative of the fee or fees calculated in sub-step (e)(ii).

In an embodiment, the cost data is indicative of each fee calculated in sub-step (e)(ii).

In an embodiment, the system automatically provides the cost data to the interface. In other embodiments, the system provides the cost data to the interface only in response to a specific request from the client computer. For example, in the latter embodiments, the default action is to send the cost data to an email address held within the storage medium.

According to an eighth aspect of the present invention there is disclosed a computer implemented method for calculating a fee for undertaking one or more predetermined actions in respect of an intellectual property (IP) application, where the method makes use of a computer system to:
(a) receive an IP identifier for the application;
(b) generate IP statistics in response to the IP identifier;
(c) generate a set of selected countries; and
(d) for each country in the set of selected countries:
   (i) identify a selected fee rule; and
   (ii) being responsive to the selected fee rule and the IP statistics to calculate the fee for the one or more predetermined actions in the corresponding country.

According to a ninth aspect of the present invention there is disclosed a computer implemented method for calculating a fee for undertaking one or more predetermined actions in respect of an intellectual property (IP) application, where the method makes use of the computer system to:
(a) provide an interface for instantiation on a client computer that is remotely connected to the system via a network;
(b) receive from the interface via the network an IP identifier for the application;
(c) generate IP statistics in response to the IP identifier;
(d) generate a set of selected countries;
(e) for each country in the set of selected countries:
   i. identify a selected fee rule; and
   ii. being responsive to the selected fee rule and the IP statistics to calculate the fee for the one or more predetermined actions in the corresponding country; and
(f) providing to the interface cost data that is indicative of the fee or fees calculated in sub-step (e)(ii).

### BRIEF DESCRIPTION OF THE DRAWINGS

The preferred embodiments will now be described, by way of example only, with reference to the accompanying drawings in which:

FIG. 1 is a block diagram of a computer system, according to an embodiment of the invention, for calculating country-specific fees;

FIG. 2 is a flow diagram illustrating a process, according to an embodiment of the invention, of generating a set of selected countries;

FIG. 3 is a flow diagram, according to an embodiment of the invention, illustrating a process of generating IP statistics;

FIG. 4 is a schematic diagram, according to an embodiment of the invention, illustrating a process of applying the fee rules to the IP statistics according to the invention;

FIG. 5 is a block diagram illustrating an IP statistics table according to an embodiment of the invention;

FIG. 6 is a block diagram illustrating a process, according to an embodiment of the invention, of populating a specification statistics table for European patents;

FIG. 7 is a block diagram illustrating a process, according to an embodiment of the invention, of populating a specification statistics table for PCT patent applications;

FIGS. 8A and 8B are respective screen shots of an interface, according to an embodiment of the invention, for creating a set of favorite countries;

FIG. 9 is a screen shot of an interface, according to an embodiment of the invention, for receiving an IP identifier and generating a 1-click quote;

FIG. 10 is a close-up screen shot of an interface, according to an embodiment of the invention, for receiving an IP identifier and generating a 1-click quote;

FIG. 11 is a screen shot of an interface, according to an embodiment of the invention, for displaying country-specific fees;

FIG. 12 is a screen shot of an example interface widget according to a second preferred embodiment of the invention; and

FIG. 13 is a screen shot of an example set of fee results produced by the example interface widget of FIG. 12.

### DETAILED DESCRIPTION OF THE PREFERRED EMBODIMENTS

In the description and claims, use is made of the term “country” to indicate a jurisdiction to which an intellectual property right, or an application for an intellectual property right, pertains. It will be appreciated that, unless the context clearly indicates otherwise, this term country is intended to also cover “region” or multiple countries if such an intellectual property has a nature which extends or applies to such a region or countries.

In the description and claims the terms “intellectual property” and “industrial property” are used interchangeably and both are abbreviated with the term “IP”.

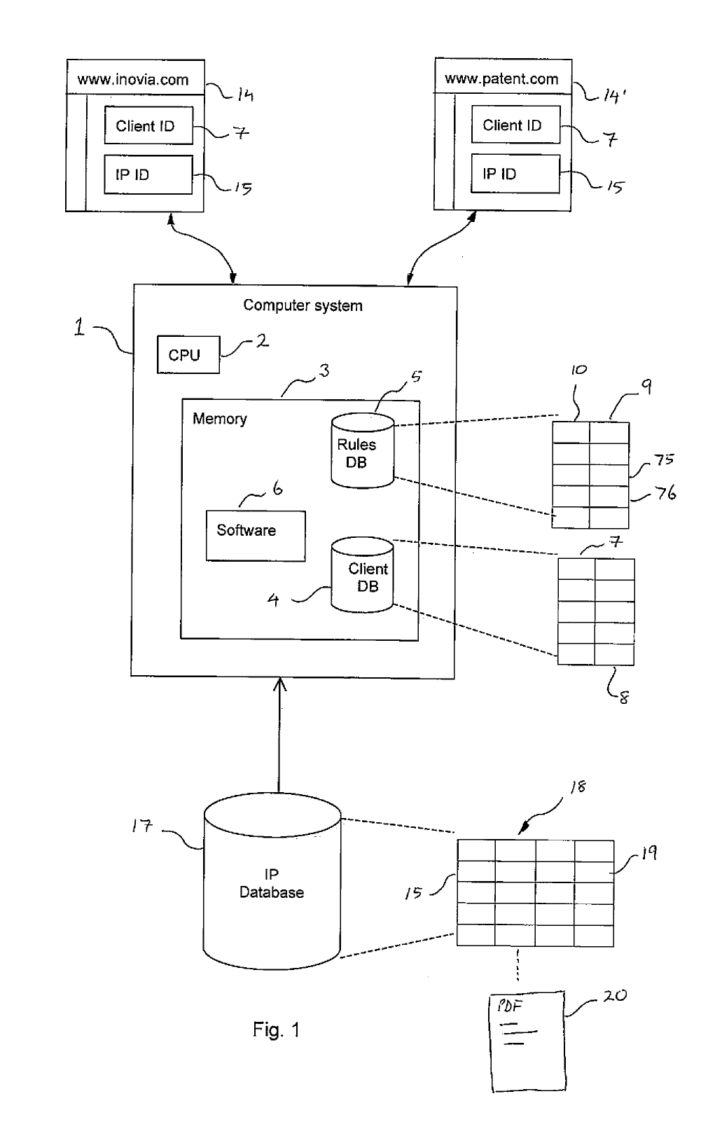

FIG. 1 shows a computer system 1 for calculating country-specific fees. The computer system has a central processing unit 2 and a computer-readable storage medium in the form of a memory 3. The memory has a client database 4, a rules database 5 and program instructions in the form of software 6 stored thereon. The computer system 1 is in communication with an interface 14 and an IP database 17.

In a first embodiment the interface 14 is located on the same server as the computer system 1. In a second embodiment, the interface 14′ is located remotely from the computer system 1 and is accessed via a computer network. The interface 14, 14′ is configured to receive an industrial property (IP) identifier 15, 15′ and to provide it to the computer system 1, preferably along with a client identifier 7, 7′.

The IP database 17 is preferably located remotely from the computer system 1 and is accessed via a computer network.

The client database 4 is configured to store a plurality of client identifiers 7 and corresponding client preferences including lists of predefined countries 8. In the preferred embodiment, the predefined countries 8 are a list of countries which correspond to a particular industrial property (IP) product or process. For example, the predefined countries 8 for a PCT application would be the list of countries into which the client normally enters the national stage. For a European patent, the predefined countries 8 would be the list of countries in which the client normally validates the European patent after grant.

The client preferences preferably also include, for each client, a set of agent-country pairs 81. These pairs identify the preferred foreign patent attorney agents the client likes to use in each country. Preferably, these pairs will include a default agent for each country.

The rules database 5 is configured to store: a plurality of country-specific fee rules 9, each corresponding to an offered country; a plurality of agent-specific fee rules 75, each corresponding to a set of default fees charged by a particular foreign patent attorney firm; and a plurality of client-specific fee rules 76, each corresponding to the fees negotiated with one or more of the attorneys by a particular client.

Preferably, an offered country 10 is a country which is available for entry, as determined by the organisation operating the computer system. For example, in the case of a PCT application, although at present there are over 140 PCT countries signatories to the PCT, the organisation operating the computer system may only include as the offered countries a smaller number of countries. For example, in this embodiment, the 30 countries most regularly selected by patent applicants are included within the offered countries. However, in other embodiments, a different sub-set of countries is offered.

Each country-specific rule specifies particular fees to be paid in each country when a foreign filing is made, regardless of the foreign agent being used. An example of these rules include the rules for calculating the official government fees payable to enter the national phase of a PCT application in a given country or region.

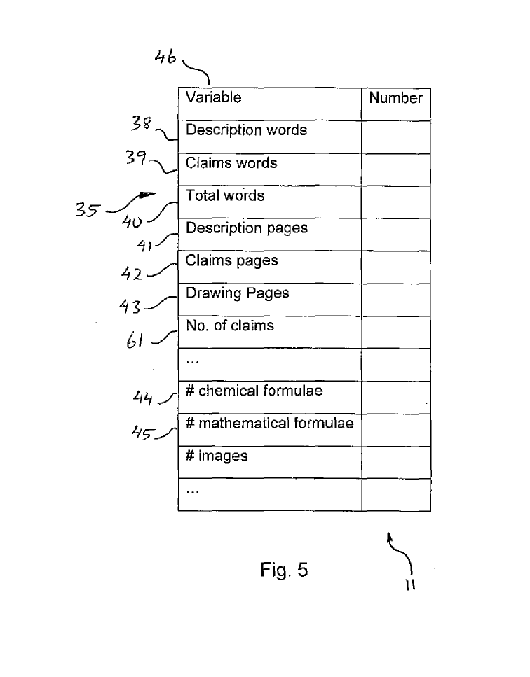

The agent-specific fee rules 75 correspond to the fees which a foreign attorney would charge for that particular case. For example, in the case of a PCT application that needs to enter the national stage in China, the agent-specific fee rules 75 would cover the services to pay the attorney for lodging the application and their fees for translating the specification into Chinese. Some or all of these fees will only be calculable with reference to certain IP statistics (not shown in FIG. 1), which in this example relate to one or more features of the PCT application. The IP statistics, which are designated in the figures with reference numeral 11, will be discussed in more detail later with reference to FIG. 5.

The client-specific fee rules 76 are similar to the agent-specific fee rules 75 in that they relate to the foreign attorney charges associated with the IP filing. However, a client may have negotiated a specific cost structure with a particular firm, so the patent firm would need to be able to charge two or more different sets of fees.

The IP database 17 is configured to store IP information including a plurality of IP identifiers 15 and electronic records 18 corresponding to the IP identifiers 15. Preferably, the IP identifiers 15 are IP application numbers such as patent application or publication numbers. More preferably, the IP identifiers are PCT application numbers or European patent application numbers. Preferably the electronic records 18 which correspond to a patent identification number include both bibliographic information 19 and an electronic patent specification 20.

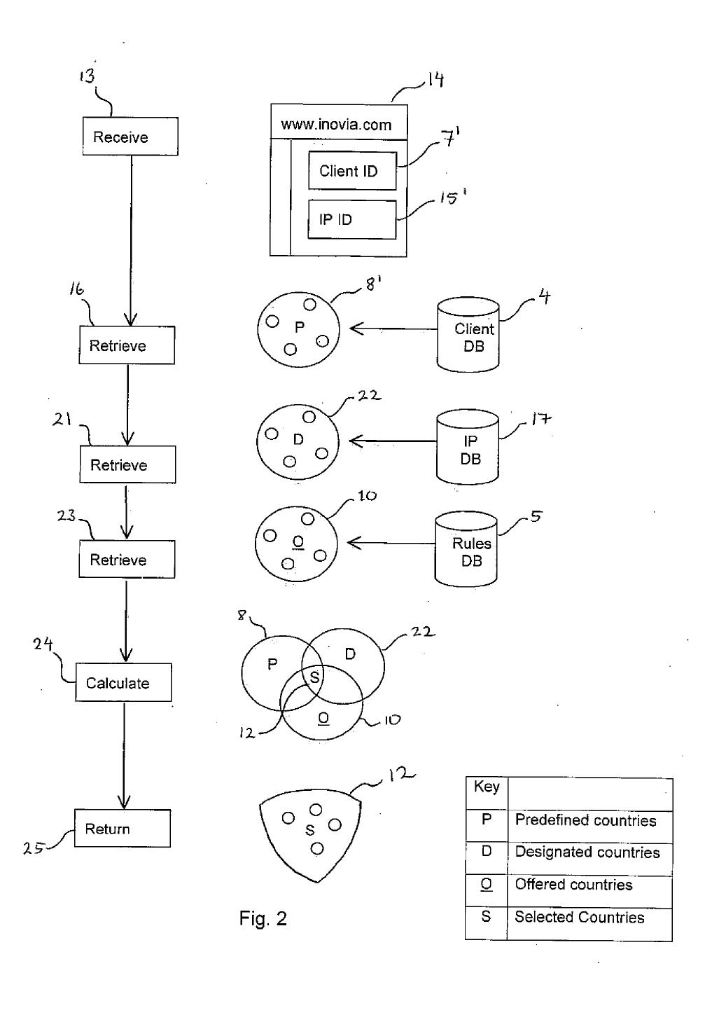

The software 6 of this preferred embodiment is programmed to perform a number of functions, as illustrated in FIGS. 2, 3 and 4.

FIG. 2 shows the steps the software 6 performs to generate a set of selected countries 12. First, the software 6 receives at step 13 a particular client identifier 7′ and a particular industrial property (IP) identifier 15′ from the interface 14. Preferably, the interface 14 receives the particular client identifier 7′ from a user (not shown). In the preferred embodiment, the particular client identifier 7′ is a user name or email address which a user employs to log in to a secure website through which interface 14 is able to be accessed. The particular client identifier 7′ is an identifier which uniquely identifies either a particular person or a particular client organisation.

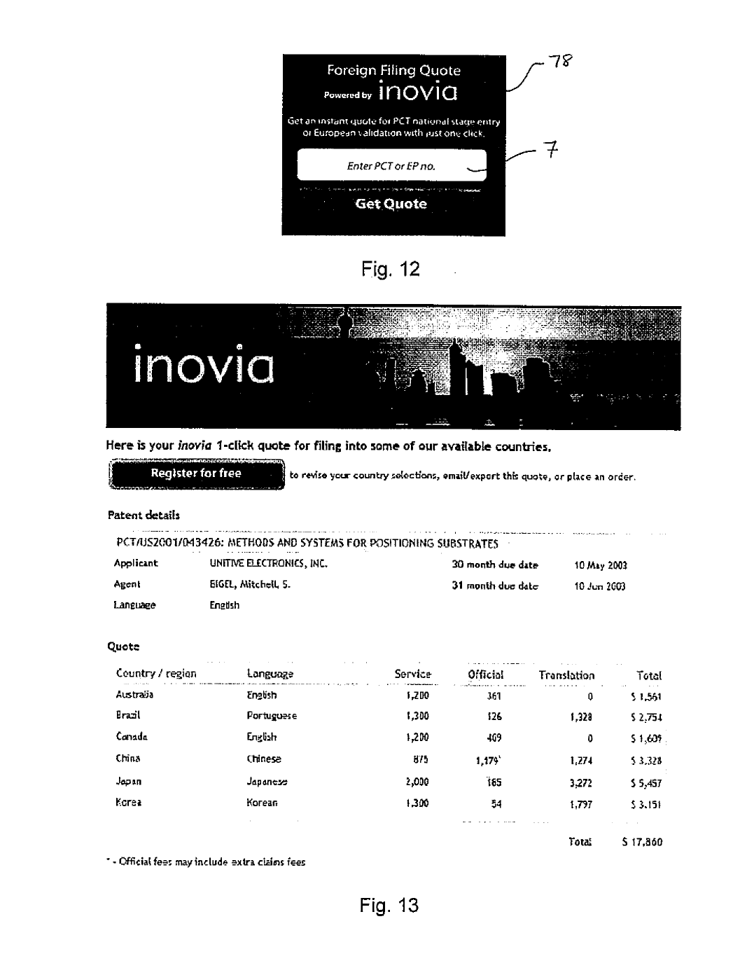

In a second embodiment, the interface 14′ is operated by a third party organisation and the client identifier 7′ is not the end-user's identifier, but an identifier of the third party. This second embodiment is illustrated later in greater detail with reference to FIG. 12.

In a third embodiment, the interface 14 does not provide a client identifier 7′ to the computer system, but the computer system 1 instead infers a client identifier 7′ from one or more of:
(a) the particular IP identifier 15′;
(b) identifying data associated with the interface 14 (not shown);
(c) the IP address of the user's computer; and
(d) the client database 4.

For example, in the case of a patent application, the computer system is able to use the particular IP identifier 15′ to retrieve the bibliographic data 19 from the IP database 17. That bibliographic data includes the applicant's name and the legal representative's name. The computer system 1 then searches the client database 4 to find whether the applicant or the legal representative have previously made use of the services of the service provider. If so, the computer system returns the client identifier 7′ associated with that applicant or legal representative.

Similarly, if neither the applicant nor the representative were included in the client database, the computer system is able to use the IP address of the user's computer to determine an approximate physical location of the user. The computer system then identifies which of the applicant's address and the legal representative's address the IP address most closely corresponds to and allocates a new client identifier 7′ corresponding to the applicant or the legal representative.

The identifying data associated with the interface may, for example, be the name of a third party hosting the interface on its website. By cross-referencing the third party name with its list of clients and the applicant and legal representative in the bibliographic data, the correct client identifier is often able to be ascertained.

In the case where a particular client identifier 7′ cannot be found by the methods included in software 6, the system 1 will allocate a new client identifier 7 and set a pricing level corresponding to the IP address of the user's computer. For example, one pricing level is set for users ascertained as being located in North America and a separate pricing level is set for users ascertained as being located in Europe. Whilst in the case of a regular client, the pricing level would be set during discussions with the service provider, when automatically creating a pricing level, the system is able to be responsive to level based on rules associated with the user's location. In other embodiments, system 1 is responsive to the ascertained location of the user for setting the currency in which the pricing is expressed to the user. In a fourth embodiment of the present invention, the interface 14 is embedded in a third party IP management software program (not shown). In this embodiment the interface 14 provides the IP identifier 7 to the computer system 1 via a web services interchange. In this interchange, the program provides a quote request (not shown) to the computer system 1 in the form of an XML file constructed according to an agreed WDSL. The quote request includes the IP identifier 15, and other parameters including the countries requested, the client identifier 7 and the identity of the provider of the IP management software 79. In other embodiments, the quote request includes only the IP identifier 15.

When the computer system 1 receives the quote request, it performs the calculation in accordance with the embodiment described below and returns to the IP management software 79 a quote response (not shown). The quote response, in its preferred form, is an XML file constructed according to an agreed WDSL. The quote response includes the IP identifier 15 and the fee results 36. The quote response in other embodiments also includes other information such as the countries selected, a breakdown of the fees either by country of by fee type, the names of the selected agents, the client identifier 15, the time and date of the calculation, the IP statistics 32, 33, 34 and the like.

A technical advantage of this web services embodiment of the present invention is that the applicant's fee calculation system is effectively embedded into third party software systems without the need for extensive and expensive integration efforts that is typically of combining systems of differing functionality. The use of XML as a common language, allows an IP software provider to have a very thin client interface. It will be appreciated, that most IP management software programs store an IP identifier 15. If the only thing those systems have to do is pass the IP identifier 15 to the computer system 1, then the IP software providers do not need to build into their system the complex calculation engines of the present invention. This not only obviates the considerable and typically cumbersome integration requirements, but also allows processing time to be minimised by moving the calculation processing to the powerful remote server upon which the computer system 1 of the present embodiment is hosted.

Returning to FIG. 2, the particular IP identifier 15′ is preferably an industrial property application number. In this example, the IP identifier 15′ is a patent application (or publication) number.

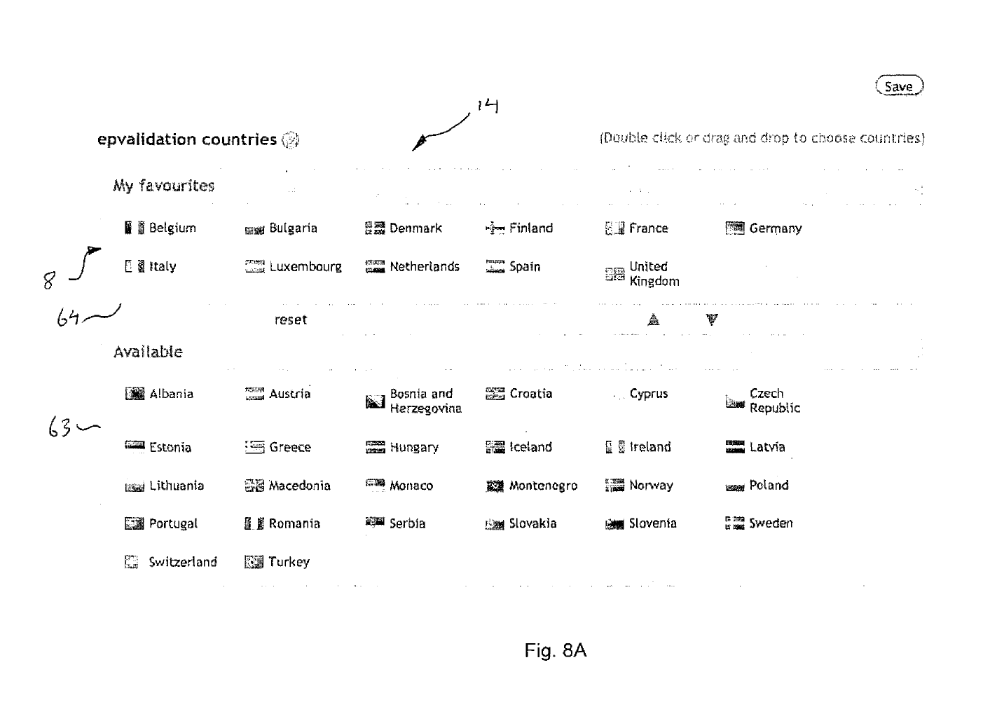

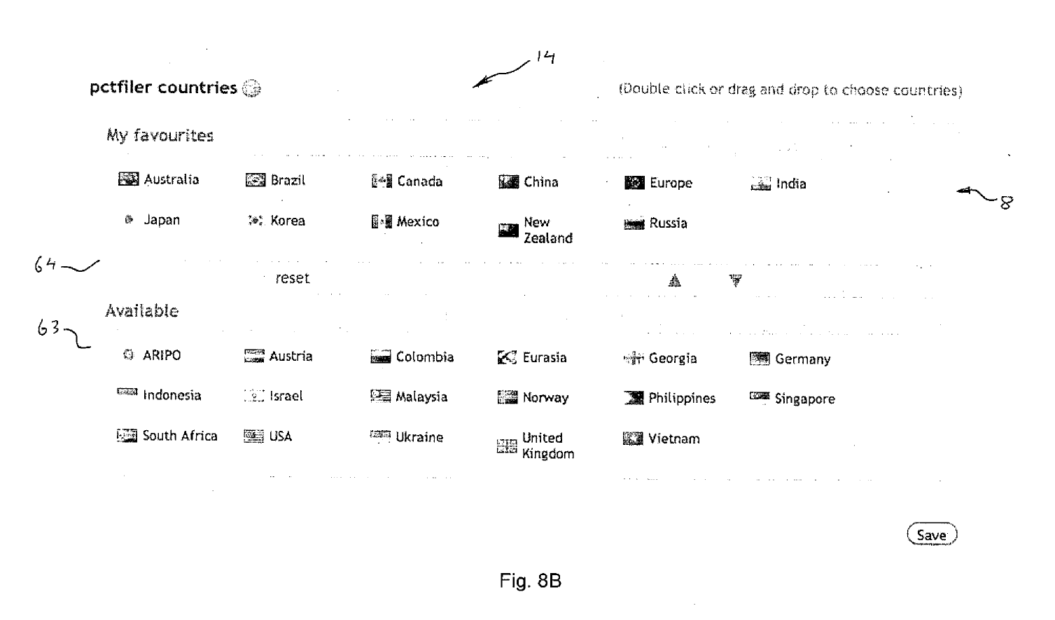

Next, the software 6 retrieves at step 16, from the client database 4, the list of predefined countries 8′ associated with the client identifier 7′. Preferably, these predefined countries 8′ have been set up earlier by the user and which correspond to the list of countries the client normally files into. Further details are provided below with reference to FIGS. 8A and 8B.

Then, the software 6 uses the particular IP identifier 15′ to search the IP database 17 and retrieve at step 21 a set of designated countries 22 contained in the bibliographic information 19 corresponding to the particular IP identifier 15′. In this example, the particular IP identifier 15′ is a PCT application and the list of designated countries 22 corresponds to the list of countries that the applicant selected/designated when filing the application as those countries which the applicant wanted to reserve the right to enter the national stage. Those skilled in the art will understand the concept of “designated countries” and that it can be applied to a variety of international or regional IP applications, including but not limited to European patent applications, PCT applications, ARIPO, OAPI and Eurasian patent applications and the like. Those skilled in the art will also appreciate that selections or designations may be automatic or implicit, as is typically the case with European applications. They will also understand that the countries comprising the designated countries may depend upon the filing date of the application.

Next, the software 6 retrieves at step 23 the list of offered countries 10 from the rules database 5.

The software 6 then calculates at step 24 the intersection between the set of predefined countries 8, the set of designated countries 22 and the set of offered countries 10 to return at step 25 a set of selected countries 12. The set of selected countries 12 therefore corresponds to the list of countries that (a) the user has expressed an interest in continuing to pursue protection (b) were designated when the IP application was originally filed, and are therefore available to be entered; and (c) are offered by the service provider operating the computer system. This set of selected countries 12 is therefore the set of countries available to be entered by the user, using the service provider.

In an alternative embodiment, the set of selected countries 12 consist of the intersection between one or two of the sets of countries—where the three sets include: the predefined countries 8; the designated countries 22; and the offered countries 10—depending upon the purpose of the calculation. In one version, the service provider is only interested in calculating estimates of foreign filing fees for any service provider, and hence would not limit the calculation to just offered countries 10.

In a further alternative embodiment, the list of predefined countries 8 is a default set of countries set up by the service provider. In this example, the first time the computer system 1 calculates a country-specific foreign filing fee for a user, the fees for that default set of countries would initially appear.

In the second embodiment described with reference to FIG. 12, the predefined countries 8 comprise a subset of the most popular countries. By not providing all available countries, the system only provides part of the information the user is interested in. To gain full access to all countries, the user is encouraged to complete a registration process. An example of the results achieved by providing a subset of the most popular countries appears in FIG. 13.

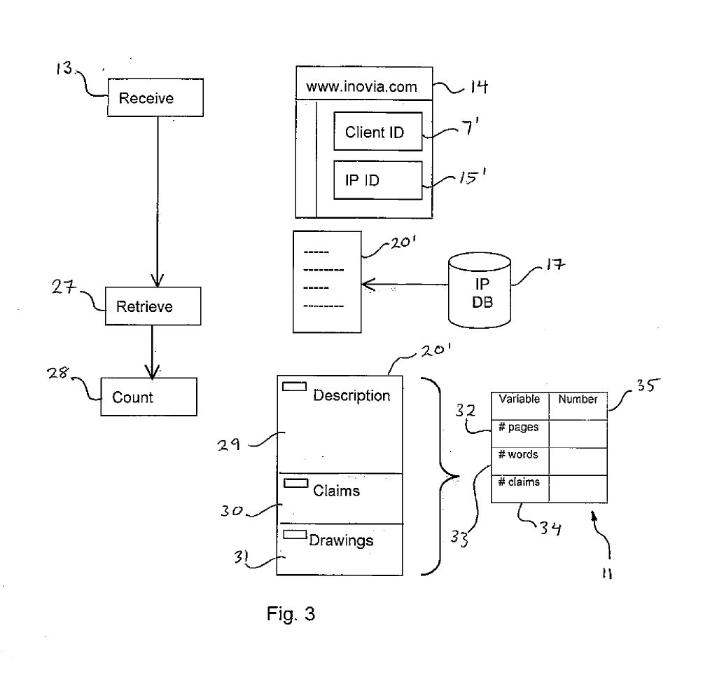

Turning now to FIG. 3, the preferred embodiment of the software 6 is also programmed to generate IP statistics 11 in a number of steps. After the computer system 1 receives at step 13 the particular IP identifier 15′ via the interface 14, the software 6 uses the particular IP identifier 15′ to search the IP database 17 and retrieve at step 27 a copy of a particular electronically stored patent specification 20′ corresponding to the particular IP identifier 15′. The particular patent specification 20′ has a number of sections, including a description section 29, a claims section 30 and a drawings section 31.

The software 6 then counts at step 28 the number of pages 32, the number of words of text 33 and the number of claims 34 contained in the electronic patent specification 20 and stores data indicative of all these IP statistics 11 in an IP statistics table 35. A preferred embodiment of the IP statistics table is described in detail below with reference to FIG. 5.

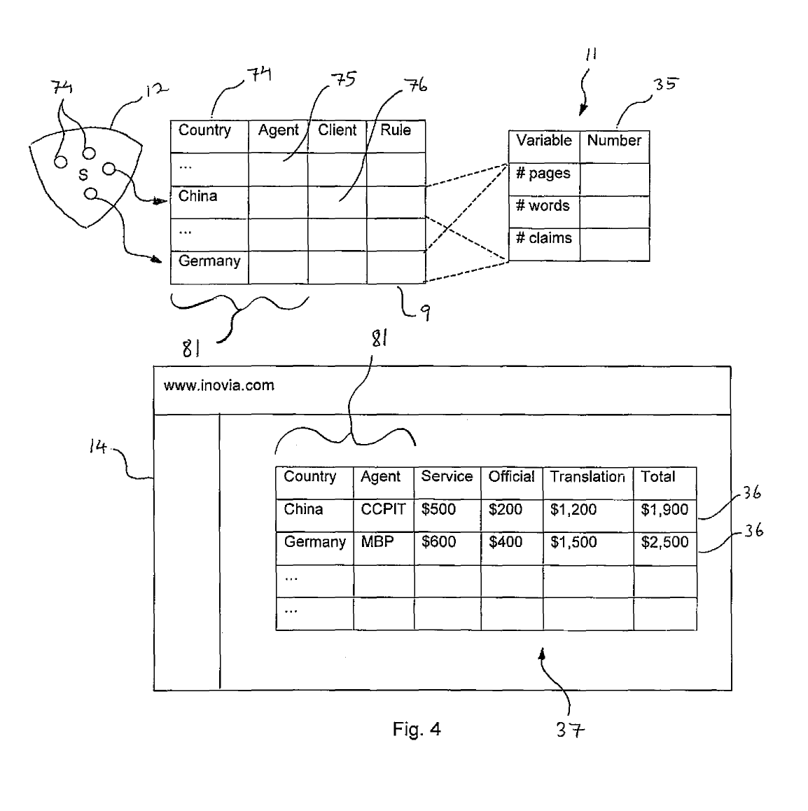

Turning now to FIG. 4, after the software 6 has generated the set of selected countries 12 and the IP statistics 11 it then determines the correct fee rules to apply. The software 6 searches the rules database 5 to identify any agent-country pairs 81 that apply to the particular client identifier 7′ and selects the corresponding fee rule (whether it be a country-specific fee rule 9, an agent-specific fee rule 75 or a client-specific fee rule 76).

In the preferred embodiment, when applying a particular fee rule, the computer system 1 would apply the following hierarchy:
First: apply country-specific fee rule 9;
Second: if no client-specific fee rule 76 applies, apply agent-specific fee rule 75, otherwise apply client-specific fee rule 76.

As shown in FIG. 4, the software 6 goes through each selected country 74, identifies the appropriate fee rule, then applies the fee rule to the IP statistics 11 in the IP statistics table 35 to produce fee results 36 for each country. In the preferred embodiment, the software 6 stores the fee results 36 in a fee results table 37 and displays the fee results table via the interface 14 for viewing by the user.

In one embodiment the software 6 returns multiple fee results 36 per country, each fee result corresponding to the fees charged by different foreign agents. By returning the fee results 36 for multiple agents simultaneously, the system does not have to perform further re-calculations if the user selects an alternative agent.

It is envisaged in one embodiment that whilst the computer system 1 returns multiple fee results 36 for each country, the interface 14 only displays one result, corresponding to a particular foreign agent. That way, if the user selects an alternative agent, the interface 14 does not have to send another request to the computer system, but can simply display the alternative fee result 36 for the alternative agent. Such an embodiment not only reduces the amount of data transmitted from the interface 14 to the computer system 1 over the computer network, it also reduces the processing time needed to be performed by the computer system 1. Such an embodiment further reduces the response time taken from requesting the alternative agent, to presenting the result on the interface.

In the preferred embodiment, the computer system 1 is configured to calculate the country-specific fees 36 in response to a single user action, such as clicking a button, clicking a link or speaking a sound. This single-action calculation of country-specific fees is able to be accomplished because the only information the user needs to provide is an IP identifier 15. The user does not have to provide the number of pages or words of the specification or the number of claims. The computer system 1 generates all of those IP statistics automatically. In addition, because the system 1 remembers the user's set of predefined countries 8, the user does not have to provide any country-selection information. Similarly, because the computer system stores the user's set of default foreign attorneys (or group of foreign attorneys), the user does not have to provide that information any more than once. This pre-selection of countries and agents is particularly true in secure website versions of the software 6, where the client has to log in and their user name (and hence the client identifier 7′) is known. Because the computer system stores this pre-defined country information and agent information, and because it is able to automatically calculate the IP statistics for the application—such as the numbers of pages, words etc in the specification—it does not need to receive that information from the user interface. The passing of minimal data (either just the IP identifier and or the client identifier) from the user interface 14 results in several technical advantages of the present invention. One advantage is the reduction in data that needs to be passed from the interface 14 to the computer system 1. Where the interface is located remotely, this technical feature results in the technical effect of reduced data traffic over the network. This decreases the time it takes to produce a cost estimate. Similarly, because the interface 14 only needs to collect and pass minimal information to the computer system 1, the interface can be deployed remotely in thin client applications with minimal technical set-up.

One example is provided in reference to FIG. 12 where a widget 78 is deployed on a simple HTML website. Deploying such an interface in a third party website involves a simple change to the site's HTML code. In that example the widget 78 is configured to receive an IP identifier 7 and provide the identifier 7 to the computer system by way of a javascript “jquery” call. Enacting the jquery call involves minimal information passage via the computer network and all of the processing and fee calculation is performed in the computer system 1, which is preferably located in a remote server with a high degree of processing power. The combination of technical features of the present invention allows the server computer system to handle the vast majority of the processing, rather than having processing located in the interface (often located on a client's local computer). In this way the present invention has the technical advantage that computer processing time is greatly reduced.

The following provides a lower level of detail of certain aspects of the preferred embodiment of the present invention.

FIG. 5 shows an example IP statistics table 35, which in this example is a patent specification statistics table. As many fee rules for PCT national stage entry and European validation depend upon a variety of variables 46, and since there are over 140 PCT countries and over 30 European validation countries, many variables 46 need to be known in order to accurately calculate the country-specific fees 36 in a variety of countries.

In this example, the IP statistics table 35 includes the following (non-exhaustive list of) variables 46:

(a) description words 38 indicating the number of words in the description section of the specification;

(b) claims words 39 indicating the number of words in the claims section of the specification;

(c) total words 40 indicating the total number of words of text in the specification;

(d) description pages 41 indicating the number of pages in the description section of the specification;

(e) claims pages 42 indicating the number of pages in the claims section of the specification;

(f) drawings pages 43 indicating the number of pages in the drawings section of the specification;

(g) No. of chemical formulas 44 indicating the number of chemical formulas within the text of the specification; and

(h) No. of mathematical formulas 45 indicating the number of mathematical formulas within the text of the specification.

The process of generating the IP statistics 11 will vary according to the types of data available and the type of IP. The following illustrative examples describe the process of generating IP statistics for a European patent that needs to be validated in various European countries and for a PCT application which needs to enter the PCT national stage.

### Generating IP Statistics for a European Patent

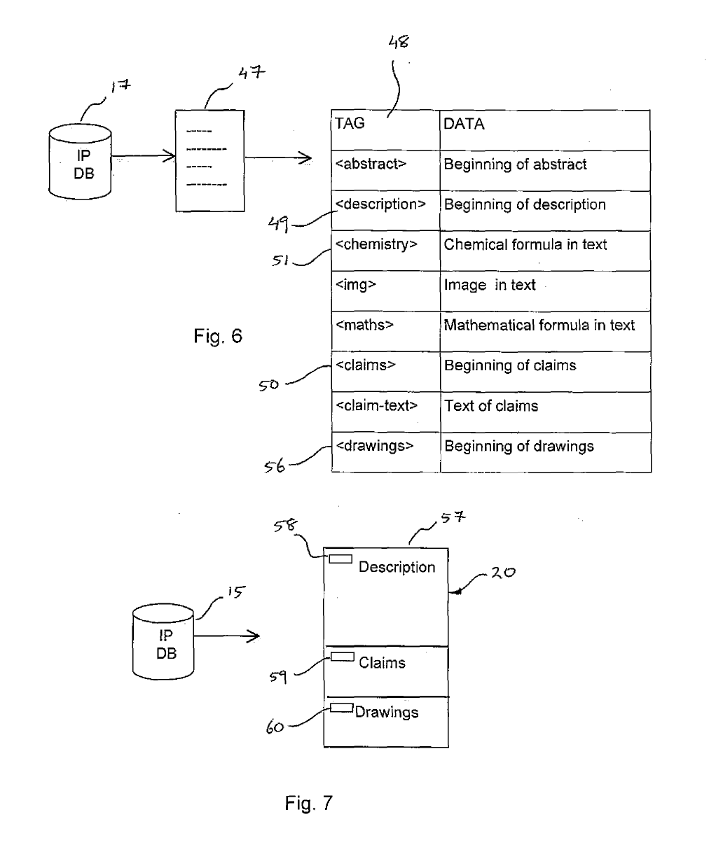

Turning to FIG. 6, the IP database 17 in the case of a European patent takes the form of the Espace NB XML files 47 which are downloadable from the European Patent Office on a weekly basis. These files contain data about published A and B documents, with A-documents representing un-granted patent specifications associated with patent applications and B-documents representing patent specifications associated with granted patents.

The XML files 47 contain a plurality of section indicia in the form of XML tags 48 which serve to delineate sections of the specification including the description, claims and drawings. The table of FIG. 6 illustrates a variety of XML tags 48 and the corresponding data they represent.

In order to calculate the description words 38, the software 6 first extracts the text that appears after the <description> tag 49 and before the <claims> tag 50. The system them performs a number of parsing processes on the extracted text. One such parsing process separates out the text that forms part of the specification from meta data such as XML or HTML tags. The description words 38 takes into account not only the literal number of words (the text count 55), but also allocates a nominal word count where chemical formulae, mathematical formulae or images appear. This is because many translators and patent attorneys apply charges depending upon the number of these elements in the specification, since chemical formulae and the like need to be carefully reviewed and formatted.

To calculate the number of chemical formulae, the preferred embodiment counts the number of <chemistry> tags 51 in the XML file 47. It then determines a chemical count 52 by multiplying the number of chemical formula by a predetermined number of words, such as 10. A similar process is followed to get a maths count 53 corresponding to the number of mathematical formulae times the predetermined number of words, and an image count 54. The description words 39 variable is then calculated by summing the text count 55, the chemical count 52, the maths count 53 and the image count 54.

To determine the claims words 39, a similar process is undergone between the <claims> tag 50 and the <drawings> tag 56, extracting and parsing the text, counting the numbers of chemical formulae, mathematical formulae and images, multiplying them by the nominal word count for each and summing the result.

One piece of data that cannot be obtained from the A and B publication XML files is the number of pages of the specification. In this example, the software uses the IP identifier 15 to query another information service from the EPO known as the OPS Web service. It then runs a “document-enquiry” process which then allows the system to automatically determine the description pages 41, claims pages 42, and drawings pages 43. This variable is needed because the patent offices of some validation countries charge a printing fee according to the number of pages in the specification.

In order to determine the number of claims 61, the software 6 searches after the first <claims> tag 50 and then counts the number of <claims> tags 50 that appear after it. The resulting number is the number of claims 61 in the specification.

### Generating IP Statistics for a PCT Application

Although many of the processes for generating IP statistics for a PCT application are similar for those for a European patent, some are different because the data sources are different. In the case of a PCT application WIPO scans the specification text, runs an OCR process on the text and stores the electronic specification 20 as a PDF document.

As shown in FIG. 7, the software 6 retrieves 16 the electronic specification 20 from the IP database 15. In this case, the IP database is accessed via the PS web server service at WIPO.int and running the getAvailableDocuments process to return a particular PDF specification 57 corresponding to the IP identifier 15. Once retrieved, the software 6 searches the PDF specification 57 for a description bookmark 58, a claims bookmark 59 and a drawings bookmark 60, each being indicia delineating sections of the specification including the description, claims and drawings. Those bookmarks contain information corresponding to the number of pages of each of those sections. The software 6 extracts that information and stores it in the IP statistics table 35 as the description pages 41, claims pages 42 and drawing pages 43 variables.

The software 6 then extracts the text between the description bookmark 58 and the claims bookmark 59 and performs a parsing and word count process similar to that described above to return the description words 38 variable. It performs a similar process on the claims section to return the claims words 39 variable.

The following paragraphs illustrate a preferred example of the interface 14 which embodies many of the features of the present invention.

Turning to FIGS. 8A and 8B, there is shown a screen shot of a portion of the interface 14 dedicated to allowing a user to create a set of favorite countries 8, known as the my profile page. In use, in order to create the set of predefined (favorite) countries 8, the user moves a country from the available countries section 63 to the my favorites section 64 by double-clicking or dragging and dropping.

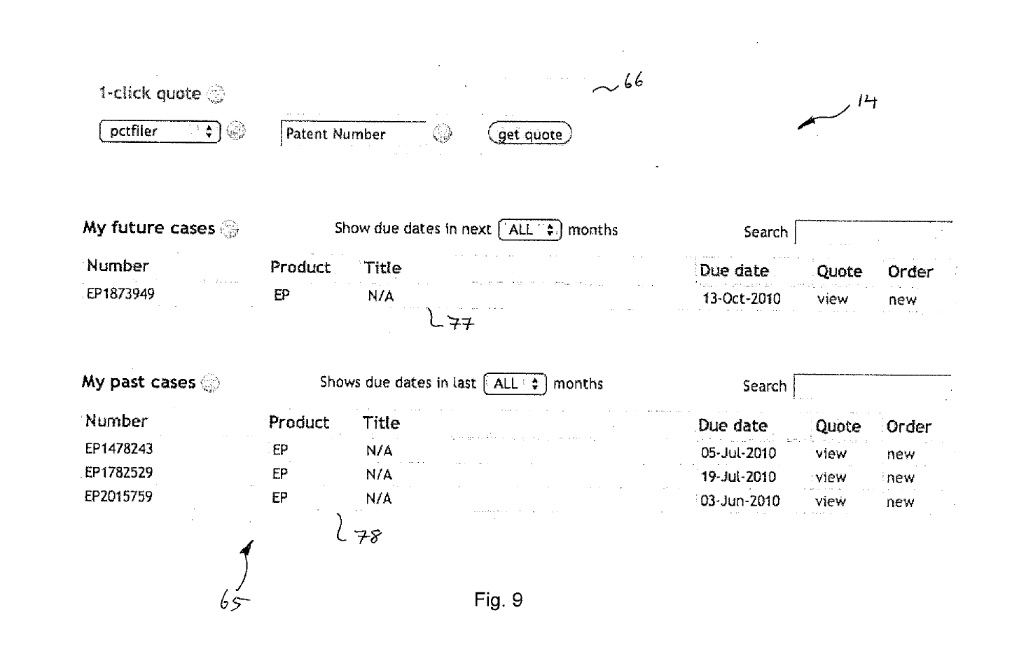

Turning to FIG. 9, there is shown a screen shot of a portion of the interface 14 dedicated to allowing a user to calculate country-specific fees in response to a single user action (or, more colloquially, generate a 1-click quote), known as the “my portfolio” page 65. The “my portfolio” page 65 has a number of sections: a 1-click quote section 66; a “my future cases” section 77; and a “my past cases” section 78.

In use, the user can generate the 1-click quote in one of two ways. He or she can either find the IP identifier 15 of interest in either the my future cases section 77 or the my past cases section 78, and click “new” or “view” in the quote column. When they perform the single user action of clicking that link, the software 6 performs all of the above-described steps to generate a foreign filing quote for the user's predefined countries.

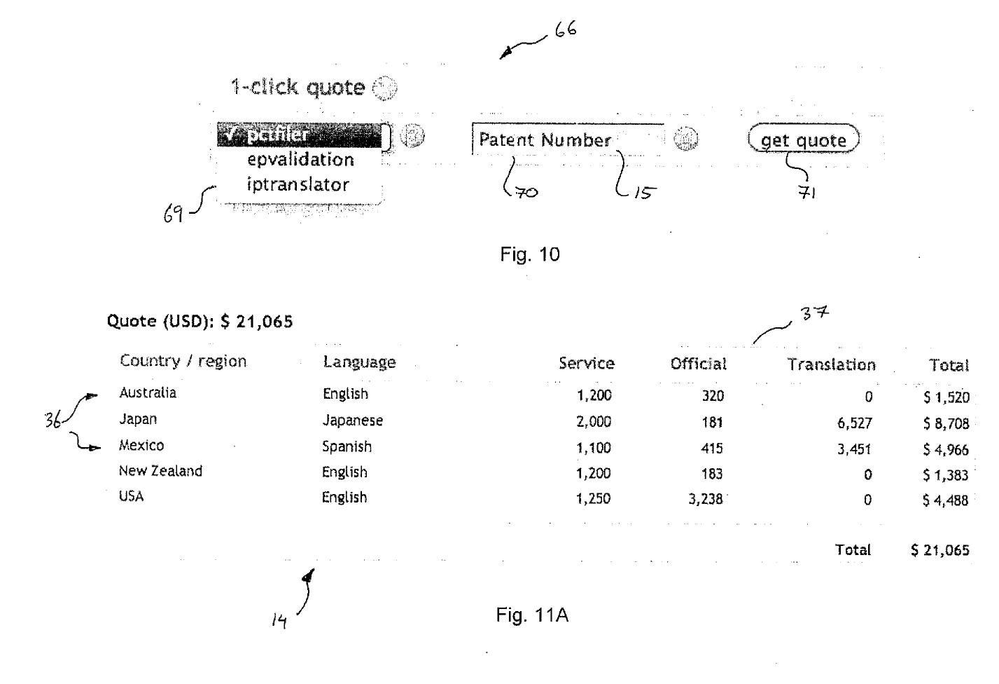

Alternatively, the user can use the 1-click quote section 66. As illustrated in FIG. 10, the user simply selects the type of IP they are interested in getting a quote for (in this case the service provider has pctfiler for PCT national stage entry, epvalidation for European validation and iptranslator for IP translations) from the drop-down menu 69, enters the IP identifier 15 in the IP identifier receiving field 70 and clicks the “get quote” button 71. When they perform the single user action of clicking that button, the software 6 performs all of the above-described steps to generate a foreign filing quote for the user's predefined countries.

In the embodiment shown in FIG. 12, the user does not even have to select the type of IP he or she is interested in. In this embodiment, the system infers the type of IP from the format of the IP identifier 7 provided. For example, a PCT application number always has the format PCT/CCNNNN/NNNNNN where CC is the country code and N is an integer. Similarly a European publication number has the format EPNNNNNNN.

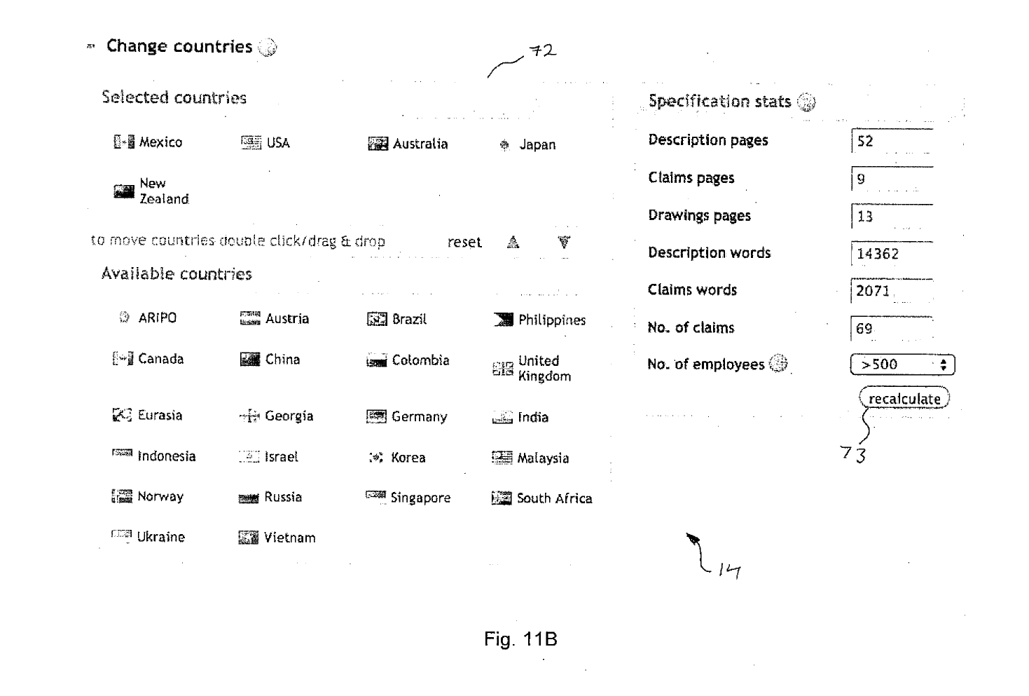

FIG. 11A shows a screen shot of a portion of the interface 14 dedicated to displaying the country-specific fees 36, according to an embodiment of the invention. This figure shows the fee results table 37 including the service fees, official fees and translation fees separately itemized. FIG. 11B shows a change countries section 72 of the same page which allows a user to modify the countries the quote has been generated for and create a new quote by clicking the recalculate button 73.

A number of variations on the above preferred embodiment are envisaged, including but not limited to the following: the steps of generating the IP statistics 11 and the set of selected countries 12 are either be calculated “on the fly” in response to a user request or generated periodically in a batch process for a large number of IP applications.

The present invention may also be applied to other types of IP such as trademarks. Instead of generating the IP statistics which, in patents, correspond to the number of pages, words and claims of the specification, the corresponding IP statistics in trademarks are the number of classes. Trademark fee rules, either government or attorney fees, often vary according to the number of classes a trademark covers. As such, the present invention could be readily applied to produce cost estimates for the filing of foreign trademark applications.

The major advantages of the above embodiments include:
A high level of accuracy.
An increased time efficiency.
A reduction in the transfer of data from the user's (or client) computer to the (remote) server computer. This reduces the network connection bandwidth required for effective operation of the embodiments, and increases the response time of the system. This is particularly advantageous for those instances when multiple computations are concerned, as large amounts of data are no longer required to be sent over a computer network including the client computer. Hence the risk of that network being slow through the use of the embodiments is reduced.
Most of the computational capacity is located at the remote server. This alleviates having to have high computational capacity at the client computer. Accordingly, the embodiments are easily applied to a large range of client computers. It has been found that by having relatively powerful remote server computers as the site for the significant computations provides for a more stable and effective implementation of the embodiments.

The above embodiments have been presented illustratively to assist the addressee understand the structure and function of those embodiments. That addressee will also appreciate, particularly given the benefit of the teaching herein, that various features and functions from the embodiments are selectively available in combination, or are interchangeable or omissible depending upon the specifics of the precise implementation of an embodiment. The intention of the inventors in providing the exemplary embodiments is to demonstrate specific implementations of the invention and not to suggest that those features and functions are not able to be added substituted or omitted from other possible embodiments.

Although the invention has been described with reference to specific examples, it will be appreciated by those skilled in the art that the invention may be embodied in many other forms, including but not limited to being embodied as devices, systems and methods.

1. A computer system for calculating country-specific fees, the computer system including a processing computer having a central processing unit and a computer-readable storage medium having instructions stored thereon and being configured to:
(a) receive an industrial property (IP) identifier;
(b) generate IP statistics corresponding to the IP identifier;
(c) generate a set of selected countries; and
(d) for each selected country:
(i) identify a selected fee rule corresponding to that country; and
(ii) apply the selected fee rule to the IP statistics to calculate a country-specific foreign filing fee.

2. The computer system of claim 1 wherein the computer system is configured to generate the set of selected countries by:
(a) receiving a client identifier;
(b) retrieving, from a client database, a set of predefined countries associated with the client identifier;
(c) retrieving, from an IP database, a set of designated countries associated with the IP identifier; and
(d) calculating an intersection between the set of predefined countries and the set of designated countries, thereby to produce the set of selected countries.

3. The computer system of claim 1 wherein the computer system is configured to generate the set of selected countries by:
(a) receiving a client identifier;
(b) retrieving, from a client database, a set of predefined countries associated with the client identifier;
(c) retrieving, from an IP database, a set of designated countries associated with the IP identifier;
(d) retrieving, from a provider database, a set of offered countries; and
(e) calculating an intersection between the set of predefined countries, the set of designated countries and the set of offered countries, thereby to produce the set of selected countries.

4. The computer system of claim 1 wherein the IP statistics include the number of pages, the number of words of text and the number of claims contained in a specification corresponding to the IP identifier and wherein the computer system is configured to generate the IP statistics by:
(a) retrieving an electronic copy of the specification from an IP database; and
(b) determining the number of pages, the number of words of text and the number of claims contained in the specification.

5. The computer system of claim 4 wherein the electronic copy of the specification contains a plurality of section indicia for delineating sections of the specification, where the sections include the description, claims and drawings and wherein the computer system is configured to count the number of pages with reference to the section indicia.

6. The computer system of claim 5 wherein the electronic copy of the specification is a PDF document, the section indicia are bookmarks and the computer system is configured to count the number of words of text in the specification by extracting the text between a pair of bookmarks and running a word count process on that text.

7. The computer system of claim 5 wherein the electronic copy of the specification is an XML document, the section indicia are XML tags and the computer system is configured to count the number of words of text in the specification by extracting the text between a pair of tags and running a word count process on that text.

8. The computer system of claim 5 wherein the IP statistics further include a chemical formula statistic corresponding to the number of chemical formulae in the specification,
and wherein the presence of a chemical formula in the specification is indicated by at least one chemical formula tag in the electronic copy of the specification,
and wherein the computer system is further configured to calculate the number of chemical formulae in the specification by counting the number of chemical formula tags.

9. The computer system of claim 5 wherein the IP statistics further include a mathematical formula statistic corresponding to a number of mathematical formula in the specification,
and wherein the presence of a mathematical formula in the specification is indicated by at least one mathematical formula tag in the electronic copy of the specification,
and wherein the computer system is further configured to calculate the number of mathematical formulae in the specification by counting the number of mathematical formula tags.

10. The computer system of claim 5 wherein the IP statistics further include an images statistic corresponding to the number of images within the text of the specification,
and wherein the presence of an image within the text of the specification is indicated by at least one image tag in the electronic copy of the specification,
and wherein the computer system is further configured to calculate the number of images within the text of the specification by counting the number of image tags.

11. The computer system of claim 6 wherein the word count process includes a parsing process configured to exclude from the word count text having predetermined characteristics.

12. The computer system of claim 11 wherein the predetermined characteristics include at least one of:
(a) html tags;
(b) xml tags;
(c) meta data;
(d) line numbers;
(e) page numbers; and
(f) commas.

13. The computer system according to claim 1 that is configured to calculate the country-specific fees in response to a single user action.

14. The computer system according to claim 1 that is configured to receive the IP identifier in response to a single user action.

15. The computer system according to claim 2 that is configured to receive both the client identifier and the IP identifier in response to a single user action.

16. The computer system according to claim 13 wherein the single user action is clicking a button.

17. (canceled)

18. (canceled)

19. (canceled)

20. A computer-implemented method of calculating country-specific fees including the steps of,
in a computer system having a processing computer having a central processing unit and a computer-readable storage medium having instructions stored thereon:
(a) receiving an industrial property (IP) identifier;
(b) generating IP statistics corresponding to the IP identifier;
(c) generating a set of selected countries; and
(d) for each selected country:
(i) identifying a selected fee rule corresponding to that country; and
(ii) applying the selected fee rule to the IP statistics to calculate a country-specific fee.

21. A computer system for calculating country-specific fees,
the computer system including a processing computer having a central processing unit and a computer-readable storage medium having instructions stored thereon and being configured to:
(a) receive an industrial property (IP) identifier;
(b) generate IP statistics corresponding to the IP identifier;
(c) generate a set of selected countries;
(d) identify at least one attorney associated with the selected country; and
(e) for each selected country and attorney pair:
(i) identify a selected fee rule corresponding to that country and attorney pair; and
(ii) apply the selected fee rule to the IP statistics to calculate a foreign filing fee.

22. A computer system for calculating country-specific fees,
the computer system including a processing computer having a central processing unit and a computer-readable storage medium having instructions stored thereon and being in communication with an IP database and a client database,
the IP database being configured to store applicant and legal representative data corresponding to a plurality of IP records, and
the client database being configured to store a plurality of client identifiers and associated client preference data,
the computer system being configured to:
(a) receive an industrial property (IP) identifier;
(b) generate IP statistics corresponding to the IP identifier;
(c) retrieve, from the IP database, applicant and legal representative data relating to the IP identifier;
(d) search the client database to find a selected client identifier matching one of the applicant or legal representative data;
(e) apply client preference data corresponding to the selected client identifier to generate a set of selected countries; and
(f) for each selected country:
(i) identify a selected fee rule corresponding to that country; and
(ii) apply the selected fee rule to the IP statistics to calculate a country-specific foreign filing fee.

23. A computer system for calculating country-specific fees,
the computer system including a processing computer having a central processing unit and a computer-readable storage medium having instructions stored thereon and being in communication with an IP database and a client database,
the IP database being configured to store applicant and legal representative data corresponding to a plurality of IP records, and
the client database being configured to store a plurality of client identifiers and associated client preference data,
the computer system being configured to:
(a) receive an industrial property (IP) identifier;
(b) generate IP statistics corresponding to the IP identifier;
(c) retrieve, from the IP database, applicant and legal representative data relating to the IP identifier;
(d) search the client database to find a selected client identifier matching one of the applicant or legal representative data,
(e) apply client preference data corresponding to the selected client identifier to generate a set of selected countries and at least one attorney associated with the selected country; and
(f) for each selected country and attorney pair:
(i) identify a selected fee rule corresponding to that country and attorney pair; and
(ii) apply the selected fee rule to the IP statistics to calculate a foreign filing fee.
